(19) United States
(12) Patent Application Publication
(10) Pub. No.: US 2026/0237954 A1
(43) Pub. Date: Aug. 13, 2026

(54) ULTRASHORT LIGHT PULSE GENERATOR

(71) Applicant: INDIE PHOTONICS CANADA INC., Québec City (CA)

(72) Inventors: Francois Trepanier, Québec (CA); Martin Maurel, Québec (CA); Alain Mailloux, Québec (CA); Claude Carignan, Québec (CA)

(21) Appl. No.: 19/150,816

(22) PCT Filed: Jan. 26, 2024
(86) PCT No.: PCT/CA2024/050092

§ 371 Date: Jul. 24, 2025

Related U.S. Application Data
(60) Provisional application No. 63/481,897, filed on Jan. 27, 2023.

(51) Int. Cl. H01S 3/00; H01S 3/067; H01S 3/08022; H01S 3/094; H01S 3/17

(52) U.S. Cl. CPC H01S 3/0057; H01S 3/0675; H01S 3/08027; H01S 3/094011; H01S 3/171; H01S 3/173

(57) ABSTRACT

A light pulse generator for generating ultrashort light pulses based on an optical path apt to induce a spectral broadening of light is provided. A pair of spectrally selective filters is disposed at opposite extremities of the optical path, each having a corresponding reflective spectral band. The reflective spectral bands substantially overlap, thereby defining an overlap spectral range. One or more gain region, pumped by one or more pump source, is positioned between the spectrally selective filters. A blocking filter is provided between the spectrally selective filters and is configured to remove light at wavelengths within a blocking spectral range from the optical path, the blocking spectral range including at least the overlap spectral range. A method for generating ultrashort light pulses and optical systems are also provided.

### TECHNICAL FIELD

The technical field generally relates to light sources and more particularly concerns a light pulse generator for generating ultrashort light pulses.

### BACKGROUND

Ultrafast fiber laser sources are used in a wide variety of applications across life sciences and industrial and scientific areas. Typical examples of these applications are multiphoton and time-resolved microscopy, femtosecond micromachining, generation of higher harmonics, supercontinuum or terahertz waves and two-photon polymerization. These applications typically rely on a stable source of high-energy ultrashort pulses provided by a low-power femtosecond oscillator amplified by a complex system involving several components and free-space propagation.

To improve the energy of the oscillators and reduce the complexity of the amplifying system, an ultrafast laser architecture commonly known as a Mamyshev oscillator (MO) was introduced [M. Piché, Proc. SPIE 2041, 358 (1994); Stéphane Pitois, Christophe Finot, Lionel Provost, and David J. Richardson, “Generation of localized pulses from incoherent wave in optical fiber lines made of concatenated Mamyshev regenerators,” J. Opt. Soc. Am. B 25, 1537-1547 (2008)]. In Mamyshev oscillators, stable Mode-locking (or pulse generation) is achieved by a periodic nonlinear spectral broadening by self-phase modulation (SPM) allowing resonant feedback between two offset spectral filters. Mos were developed to reach unprecedented peak power levels in ytterbium-doped systems emitting at 1060 nm [Z. Liu, Z. M. Ziegler, L. G. Wright, and F. W. Wise, Optica 4, 649 (2017); W. Liu, R. Liao, J. Zhao, J. Cui, Y. Song, C. Wang, and M. Hu, Optica 6, 194 (2019)]. Such high-energy oscillators were also demonstrated in erbium-doped fibers emitting at 1565 nm [M. Olivier, V. Boulanger, F. Guilbert-Savary, P. Sidorenko, F. W. Wise, and M. Piché, Opt. Lett. 44, 851(2019)] and thulium-doped fibers emitting at 1965 nm [P. Repgen, B. Schuhbauer, M. Hinkelmann, D. Wandt, A. Wienke, U. Morgner, J. Neumann, and D. Kracht, Opt. Express 28, 13837 (2020)], although the energy at those wavelengths is limited by the availability of optical fibers with normal dispersion and low nonlinearity. Early demonstrations of high-energy MO were based on ring cavities involving free-space propagation sections to provide more control and facilitate the exploration of the parameters. Linear cavities with free-space segments were also considered. In order to simplify the design and improve the robustness of Mamyshev oscillators, all polarization-maintaining fiber linear cavities bounded by fiber Bragg gratings were also introduced [V. Boulanger, M. Olivier, F. Guilbert-Savary, F. Trépanier, M. Bernier and M. Piché, Optics Letters 45, 3317 (2020); V. Boulanger, M. Olivier, F. Trépanier, P. Deladurantaye and M. Piché, Optics Letters 48, 2700 (2023)].

There remains a need for improvements in the generation of ultrashort light pulses.

### SUMMARY

In accordance with one aspect, there is provided a light pulse generator for generating ultrashort light pulses, comprising:
an optical path apt to induce a spectral broadening of light propagating therealong;
a pair of spectrally selective filters disposed at opposite extremities of the optical path and each having a corresponding reflective spectral band, the reflective spectral bands of the spectrally selective filters substantially overlapping, thereby defining an overlap spectral range;
at least one optical gain region positioned in the optical path between the spectrally selective filters;
at least one pump source coupled to the at least one optical gain region; and
a blocking filter positioned between the spectrally selective filters and configured to remove light at wavelengths within a blocking spectral range from the optical path, the blocking spectral range including at least the overlap spectral range.

In some implementations, the optical path is composed of at least one segment of optical fiber.

In some implementations, the spectrally selective optical filters are Fiber Bragg Gratings (FBGs).

In some implementations, the overlap spectral range is at least about 10%, 30%, 80% or 90% of the reflective spectral band of the spectrally selective filters, or the overlap spectral range substantially correspond to the entire reflective spectral bands of at least one the spectrally selective filters.

In some implementations, the reflective spectral bands of the spectrally selective filters have a Gaussian-like spectral profile.

In some implementations, the blocking filter is a slanted Fiber Bragg Grating, a Long Period Grating or a bulk filter.

In some implementations, the blocking range of the blocking filter is composed of the overlap spectral range and wavelengths above said overlap spectral range.

In some implementations, the blocking range of the blocking filter is composed of the overlap spectral range and wavelengths below said overlap spectral range.

In some implementations, the blocking range of the blocking filter is composed of the overlap spectral range and wavelengths both below and above said overlap spectral range.

In some implementations, the light pulse generator comprises a light output coupled to one of the opposite extremities of the optical path and configured to output light transmitted through the corresponding spectrally selective filter.

In some implementations, the light pulse generator comprises:
a pair of light outputs, each of said light outputs coupled to a corresponding one of the opposite extremities of the optical path and configured to output light transmitted through the corresponding spectrally selective filter; and
a combiner configured to combine the light outputted by the pair of light outputs into a combined output beam.

In some implementations, each of the at least one optical gain region comprises a length of optical fiber having an active core.

In some implementations, the at least one optical gain region consists of a single optical gain region, and the at least one pump source consists of a single pump source coupled to the one of the opposite extremities of the optical fiber path closest to the optical gain region and configured to inject a pump beam adapted to pump said optical gain region along the optical fiber path.

In some implementations, the at least one optical gain region comprises two optical gain regions positioned on either side of the blocking filter.

In some implementations, the at least one pump source comprises a pair of pump sources, each pump source coupled to one of the opposite extremities of the optical fiber path and configured to inject a pump beam adapted to pump a closest one of said optical gain regions along the optical fiber path.

In some implementations, the at least one pump source comprises a single pump source coupled to one of the opposite extremities of the optical fiber path and configured to inject a pump beam adapted to pump said pair of optical gain regions along the optical fiber path.

In some implementations, the light pulse generator further comprises at least one pump stripper, each of the at least one pump stripper being coupled to the optical fiber path between a respective one of the optical gain region and the blocking filter.

In some implementations, the optical path is a free-space path, each of the spectrally selective filters and the blocking filters are Volume Bragg Gratings or thin film filters, and the blocking filter is positioned at an orientation with respect to incoming light which deflects light within the blocking spectral range out of the optical path and propagates light at other wavelengths along the optical path.

In accordance with one aspect, there is provided an optical system comprising:
a light pulse generator according to any implementation above; and
a pulse compressor configured to compress the ultrashort light pulses from the light pulse generator.

In accordance with another aspect, there is provided a Chirped Pulse Amplification (CPA) system, comprising, successively:
a light pulse generator according to any of the implementations above;
a pulse stretcher configured to stretch each the ultrashort light pulses from the light pulse generator into time-spread spectral components, thereby defining a stretched optical pulse;
an amplifier configured to increase a light intensity of the stretched optical pulses; and
a pulse compressor for compressing the amplified stretched optical pulses into amplified compressed optical pulses.

In accordance with one aspect, there is provided a method for generating ultrashort light pulses, comprising:
circulating a cavity pulse in a cavity defined by an optical path apt to induce a spectral broadening of light propagating therealong and a pair of spectrally selective filters disposed at opposite extremities of the optical path, each spectrally selective filter having a corresponding reflective spectral band, the reflective spectral bands of the spectrally selective filters substantially overlapping, thereby defining an overlap spectral range;
amplifying and spectrally broadening the cavity pulse as it propagates within said cavity;
filtering the cavity pulse using a blocking filter positioned between the spectrally selective filters and configured to remove light at wavelengths within a blocking spectral range from the optical path, the blocking spectral range including at least the overlap spectral range;
at each spectrally selective filter, reflecting a portion of the cavity pulse matching said overall spectral range for another pass within said cavity; and
at one or both of said spectrally selective filters, outputting light transmitted through said spectrally selective filter as said ultrashort light pulses.

In some implementations, the spectrally selective optical filters are Fiber Bragg Gratings (FBGs).

In some implementations, the overlap spectral range is at least about 10%, 30%, 80% or 90% of the reflective spectral band of the spectrally selective filters.

In some implementations, the overlap spectral range substantially correspond to the entire reflective spectral bands of at least one the spectrally selective filters.

In some implementations, the reflective spectral bands of the spectrally selective filters have a Gaussian-like spectral profile.

In some implementations, the blocking filter is a slanted Fiber Bragg Grating, a Long Period Grating or a bulk filter.

In some implementations, the blocking range of the blocking filter is composed of the overlap spectral range and wavelengths above said overlap spectral range.

In some implementations, the blocking range of the blocking filter is composed of the overlap spectral range and wavelengths below said overlap spectral range.

In some implementations, the blocking range of the blocking filter is composed of the overlap spectral range and wavelengths both below and above said overlap spectral range.

In accordance with one aspect, there is provided a light pulse generator for generating ultrashort light pulses, comprising:
an optical fiber path apt to induce a spectral broadening of light propagating therealong;
a pair of Fiber Bragg Gratings (FBGs) disposed at opposite extremities of the optical path and each having a corresponding reflective spectral band, the reflective spectral bands of the FBGs substantially overlapping, thereby defining an overlap spectral range;
at least one optical gain region positioned in the optical path between the FBGs;
at least one pump source coupled to the at least one optical gain region;
a blocking filter positioned between the spectrally selective filters and configured to remove light at wavelengths within a blocking spectral range from the optical path, the blocking spectral range including at least the overlap spectral range; and
at least one light output coupled to one of the opposite extremities of the optical path and configured to output light transmitted through the corresponding FBG.

In accordance with another aspect, there is provided light pulse generator for generating ultrashort light pulses, comprising:
an optical fiber path apt to induce a spectral broadening of light propagating therealong;
a pair of Fiber Bragg Gratings (FBGs) disposed at opposite extremities of the optical fiber path and each having a corresponding reflective spectral band, the reflective spectral bands of the FBGs substantially overlapping, thereby defining an overlap spectral range;
a blocking filter positioned between the FBGs and configured to remove light at wavelengths within a blocking spectral range from the optical path, the blocking spectral range including at least the overlap spectral range;
an optical gain region positioned in the optical fiber path between one of the FBGs and the blocking filter; and
a pump source coupled to the one of the opposite extremities of the optical fiber path closest to the optical gain region and configured to inject a pump beam adapted to pump said optical gain region along the optical fiber path.

In accordance with yet another aspect, there is provided a light pulse generator for generating ultrashort light pulses, comprising:
an optical fiber path apt to induce a spectral broadening of light propagating therealong;
a pair of Fiber Bragg Gratings (FBGs) disposed at opposite extremities of the optical fiber path and each having a corresponding reflective spectral band, the reflective spectral bands of the FBGs substantially overlapping, thereby defining an overlap spectral range;
a blocking filter positioned between the FBGs and configured to remove light at wavelengths within a blocking spectral range from the optical path, the blocking spectral range including at least the overlap spectral range;
a pair of optical gain regions each positioned in the optical fiber path between a respective one of the FBGs and the blocking filter; and
a pair of pump sources, each pump source coupled to one of the opposite extremities of the optical fiber path and configured to inject a pump beam adapted to pump a closest one of said optical gain regions along the optical fiber path.

In accordance with one aspect, there is provided a light pulse generator for generating ultrashort light pulses, comprising:
an optical fiber path apt to induce a spectral broadening of light propagating therealong;
a pair of Fiber Bragg Gratings (FBGs) disposed at opposite extremities of the optical fiber path and each having a corresponding reflective spectral band, the reflective spectral bands of the FBGs substantially overlapping, thereby defining an overlap spectral range;
a blocking filter positioned between the FBGs and configured to remove light at wavelengths within a blocking spectral range from the optical path, the blocking spectral range including at least the overlap spectral range;
a pair of optical gain regions each positioned in the optical fiber path between a respective one of the FBGs and the blocking filter; and
a pump source coupled to one of the opposite extremities of the optical fiber path and configured to inject a pump beam adapted to pump said pair of optical gain regions along the optical fiber path.

In accordance with another aspect, there is provided a light pulse generator for generating ultrashort light pulses, comprising:
an optical path apt to induce a spectral broadening of light propagating therealong;
a pair of spectrally selective filters disposed at opposite extremities of the optical path and each having a corresponding reflective spectral band, the reflective spectral bands of the spectrally selective filters substantially overlapping, thereby defining an overlap spectral range, the overlap spectral range covering at least 10% of the reflective spectral band of the spectrally selective filters;
at least one optical gain region positioned in the optical path between the spectrally selective filters;
at least one pump source coupled to the at least one optical gain region; and
a blocking filter positioned between the spectrally selective filters and configured to remove light at wavelengths within a blocking spectral range from the optical path, the blocking spectral range being composed of:
   the overlap spectral range and wavelengths below said overlap spectral range; or
   the overlap spectral range and wavelengths above said overlap spectral range; or
   the overlap spectral range and wavelengths both below and above said overlap spectral range.

Other features and advantages will be better understood upon reading of preferred embodiments with reference to the appended drawings.

### BRIEF DESCRIPTION OF THE DRAWINGS

FIG. 1 is a schematic representation of an ultrashort light pulse generator according to one embodiment.

FIGS. 2A and 2B show the evolution of a Gaussian pulse being broadened by SPM while propagating in a medium.

FIG. 3 is a graph showing the overlap between the reflective spectral bands of two FGBs according to one implementation.

FIGS. 4A to 4B are schematic representations of light pulse generators having blocking filters embodied by a slanted Fiber Bragg Grating (FIG. 4A), a Long Period Grating (FIG. 4B) and a bulk filter (FIG. 4C).

FIG. 5 is a schematic representation of an ultrashort light pulse generator according to one embodiment with two gain regions and pump sources.

FIG. 6 is a schematic representation of an ultrashort light pulse generator according to one embodiment with a single gain regions and pump source.

FIGS. 7A and 7B illustrate the process of generating ultrashort light pulses using the light pulse generator according to the embodiment of FIG. 1.

FIG. 8 illustrate the blocking spectral range and overlapped reflective spectral bands according to one example; FIG. 8A is an enlargement of section A of FIG. 8.

FIG. 9 illustrate the blocking spectral range and overlapped reflective spectral bands according to another example; FIG. 8A is an enlargement of section A of FIG. 9.

FIG. 10 is a schematic representation of an ultrashort light pulse generator according to one embodiment in a free-space configuration.

FIG. 11 is a schematic representation a CPA system incorporating an ultrashort light pulse generator according to one embodiment.

### DETAILED DESCRIPTION

In accordance with some implementations, there is provided a light pulse generator and a method for generating ultrashort light pulses.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

In the present description, when a broad range of numerical values is provided, any possible narrower range within the boundary of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

It is to be understood that the phraseology and terminology employed in the present description is not to be construed as limiting and are for descriptive purposes only.

Furthermore, it is to be understood that the technology can be carried out or practiced in various ways and that it can be implemented in embodiments other than the ones outlined described herein.

Meanings of technical and scientific terms used herein are to be commonly understood as by one of ordinary skill in the art to which the invention belongs, unless otherwise defined.

As known to those skilled in the art, ultrashort light pulses have a duration of the order of a few picoseconds or less. By convention, the duration of a light pulse is typically measured as the full width at half maximum (FWHM) of the peak representing the intensity or irradiance of the light pulse over time. In some implementations, the duration of the ultrashort light pulses may be less than about 10 picoseconds or less then about 1 picosecond. In one embodiment, the duration of the ultrashort light pulses is between about 1 picosecond and about 5 picoseconds. In some implementations, the duration of the ultrashort light pulses may be in the femtosecond range. Ultrashort light pulses are sometimes referred to in the art as ultrafast light pulses, the later expression however technically referring to the speed at which the light pulses travel, which may vary as a function of the refractive index of the medium in which it travels. One skilled in the art will readily understand that in practice, both expressions may be used interchangeably.

The ultrashort light pulses generated by the light pulse generator described herein may be used in a variety of contexts. Examples of applications of ultrashort light pulses include micromachining (e.g. fuel injectors, battery electrodes cutting), ophthalmology, lab-on-a-chip, semiconductor dicing, stents manufacturing, internal engraving of transparent material, etc. Generally, the ultrashort light pulses outputted by the light pulse generator require amplification prior to their use in typical applications. It is well known to amplify ultrashort light pulses using a chirped pulse amplification system. Chirped pulse amplification (CPA) is a widely used technique to amplify light pulses to high energies, while mitigating the deleterious effects of nonlinearities. This is achieved by temporally spreading each pulse before amplification to reduce peak power, followed by post-amplification compression, resulting in a short, high energy pulse train. Other strategies may use a nonlinear amplifier to favor the formation of very short pulses after compression. As examples, the ultrashort light pulses may be amplified using a gain managed systems such as for example described in US20220278498 (WISE) or with a self-similar amplifier scheme [M. Fermann, V. Kruglov, B. Thomsen, J. Dudley and J. Harvey, Physical Review Letters 84, 610 (2000)].

### Light Pulse Generator

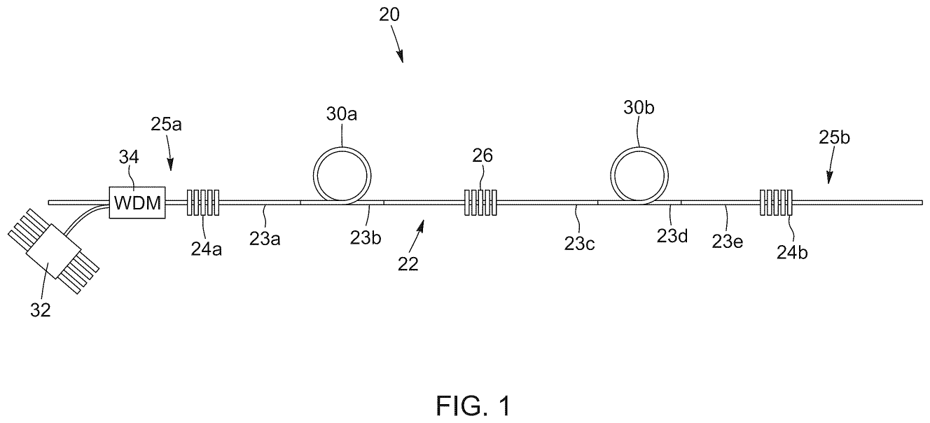

Referring to FIG. 1, a light pulse generator 20 according to one embodiment is schematically illustrated.

The light pulse generator first includes an optical path 22 apt to induce a spectral broadening of light propagating therealong.

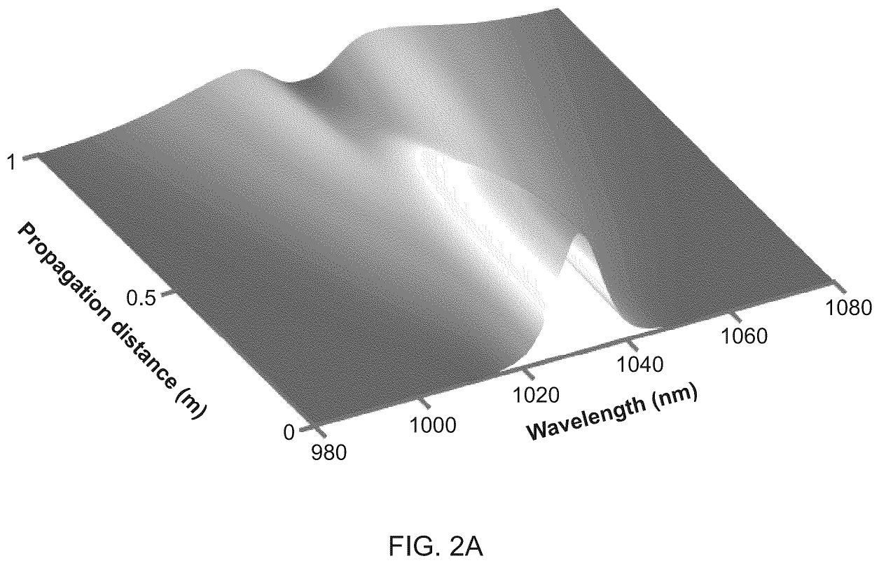

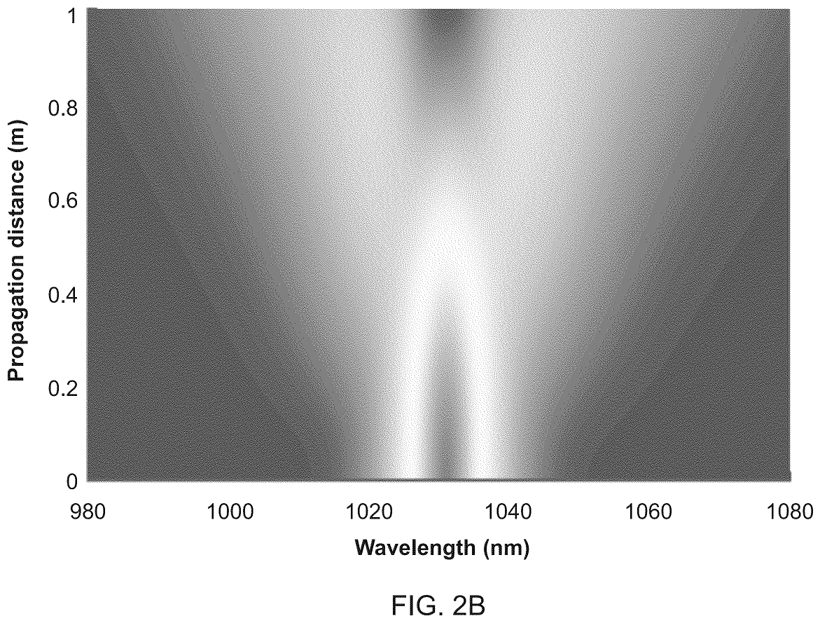

Spectral broadening refers to the increase of the number of wavelengths, i.e. the increase in the spectral contents of a light pulse as it propagates in medium. In some embodiments, the spectral broadening of the light pulses may be the result of the so-called optical Kerr effect, which refers to circumstances in which the propagation of high intensity light pulses leads to non-linear effects which modify the refractive index of the propagation medium. Different non-linear effects may be the cause of the broadening of the spectrum, such as self-phase modulation, cross-phase modulation, four wave mixing, and the like. In some embodiments, the spectral broadening of the light propagating along the optical path generally results from Self-Phase Modulation (SPM). SPM is a nonlinear optical effect whereby the propagation of an ultrashort pulse of light in a medium induces a change in the refractive index of this medium, due to the optical Kerr effect. This variation in refractive index produces a phase shift in the pulse, leading to a change in its spectral profile. By way of example, FIGS. 2A and 2B shows the evolution of a Gaussian pulse being broadened by SPM while propagating in a medium.

In typical embodiments, the optical path 22 is embodied by a length of optical fiber. The optical path 22 may be composed of a single optical fiber 23 or of a series of n different segments of optical fiber 23a, 23b, . . . , 23n that are fused, pigtailed or otherwise coupled to each other. Optical fibers are typically composed of a light guiding core and one or more cladding surrounding the core. A protective polymer coating surrounds the outermost cladding. In typical embodiments, the optical fiber of fibers embodying the optical path is or are multi-clad, that is, have a plurality of claddings. The optical fiber or fibers is or are configured to guide the light pulses in a core mode, and optionally guide pump light a cladding mode, as explained further below.

Each segment of optical fiber 23 of the optical path 22 may be of one of a variety of optical fiber types. The core and/or cladding of the optical fiber may be made of glass such as silica or any type of oxide glass and may be made of pure glass or may be doped with one or more dopants. the optical fiber may or may not be made of a photosensitive material or be photosensitized prior to the writing of a Bragg grating therein. As such, co-doping the fiber with germanium, as is known in the art to enhance photosensitivity, is not necessarily required, although in some embodiments the fiber may be germanium-doped and hydrogen- or deuterium-loaded to enhanced photosensitivity. In some embodiments, the core and/or cladding of the optical fiber may alternatively be made of a crystalline material such as a sapphire, germanium, zinc selenide, yttrium aluminium garnet (YAG) or other crystalline materials with similar physical properties. In other embodiments, the core and/or cladding of the optical fiber may alternatively be made of low phonon energy glass such as a fluoride, chalcogenide or chalcohalide glass or other glass materials with similar physical properties. The low phonon energy glass medium can be of a variety of compositions, such as, but not limited to, doped or undoped fluoride glasses such as ZBLA, ZBLAN, ZBLALi, chalcogenide glasses such as As₂S₃ or As₂Se₃ or chalcohalide glasses.

In some embodiments, one or more of the optical fiber segments 23 are Polarisation-Maintaining (PM) fibers. PM optical fibers have a strong built-in birefringence, that is, they are built so that the two orthogonal polarization modes of light propagate along the fiber at two distinct phase velocities. the segments of PM fibers may for example be PANDA type optical fibers, in which the birefringence is provided by stress rods, of a glass composition differing from the core and cladding composition, disposed on opposite sides of the core. The stress rods are typically introduced in a preform prior to drawing into the PM optical fiber.

The polymer coating (not shown), sometimes referred to as the fiber jacket or fiber coating, may be made of any suitable polymer or hybrid polymer material. For example, standard optical fibers for telecommunication or fiber lasers are typically provided with an acrylate or fluoroacrylate-based coating. In other embodiments, the polymer coating may be made of a polyimide, a silicone, a polytetrafluoroethylene (e.g. Teflon™), an organically modified ceramic (e.g. Ormocer™) and the like. In some cases, a thin layer of a hermetic material, such as carbon or metal, can be present at the polymer-to-cladding interface.

The light pulse generator 20 further includes a pair of spectrally selective filters 24a and 24b, disposed at opposite extremities 25a and 25b of the optical path 22, and a blocking filter 26 positioned between the spectrally selective filters 24a and 24b.

In some implementations, each one of the spectrally selective filters 24a, 24b and blocking filter 26 is embodied by a Fiber Bragg Grating (FBG).

Throughout the present description, the expression “Bragg grating” is used to refer to a periodic or aperiodic refractive index pattern induced in a waveguide, the expression “Fiber Bragg grating” or “FBG” being used in the art when the waveguide is an optical fiber. An FBG allows light propagating into the host optical fiber to be reflected in a counterpropagating direction when its wavelength corresponds to the Bragg wavelength of the refractive index pattern, which is related to its period. A chirped fiber Bragg grating has a period, and therefore a Bragg wavelength, which varies as a function of the position along the fiber, defining a reflectivity profile spanning over one or more wavelength bands. The period profile of a chirped Bragg grating is also designated as its dispersion profile, as different wavelengths are reflected at distinct positions along the grating, subjecting them to different delays, therefore creating a chromatic dispersion of the light pulse. The refractive index pattern can be designed to provide a dispersion profile tailored to the desired impact on the characteristics of the reflected light.

In alternative embodiments, the spectrally selective filters may be embodied by thin film filters deposited at the ends of the optical fiber segments at extremities of the optical path. In other variants, bulk or semi-bulk filters may be used.

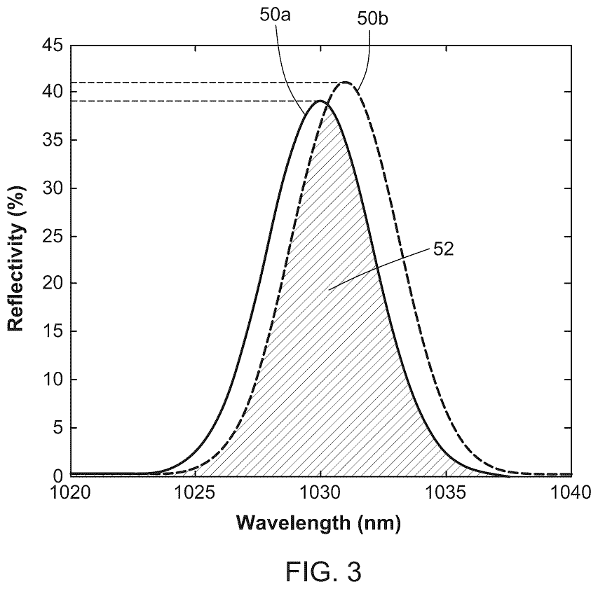

Referring to FIG. 3, in some implementations, each FBG embodying the spectrally selective filters 24a, 24b of FIG. 1 has a refractive index pattern designed to provide a corresponding reflective spectral band 50a, 50b. In some embodiments, the reflective spectral bands of the spectrally selective filters 24a, 24b substantially overlap, thereby defining an overlap spectral range 52. In typical applications, the reflective spectral bands 50, 50b of each filter may have a width of less than about 2 nm, or between about 0.5 nm and 5 nm, or between 5 nm and 10 nm. In one example, both filters may have a FWHM of the order of 1 or 2 nm. In some implementations, the two spectrally selective filters 24a and 24b have identical or nearly identical reflectivity profiles, that is, their corresponding reflective spectral bands 50a, 50b completely or almost completely overlap, for example overlapping over about 80%, about 90% or more of the reflective spectral bands of the individual spectrally selective filters. In some variants, the overlap spectral range 52 may cover at least 10% or at least 30% of the reflective spectral bands 50a, 50b of the individual spectrally selective filters.

It will be readily understood that the shapes and reflectivity levels of the reflective spectral bands 50a, 50b of the two spectrally selective filters may be identical or different. By way of example, the reflective spectral bands 50a, 50b shown in FIG. 3 both have a similar Gaussian shape, but their peak reflectivity levels are slightly different (about 39% and about 41%, respectively). In typical implementations, the peak reflectivity of each one of the spectrally selective filters may be between about 30 and about 60%. In some implementations, peak reflectivity values between about 5% and about 100% could be used depending on the other parameters of the oscillator.

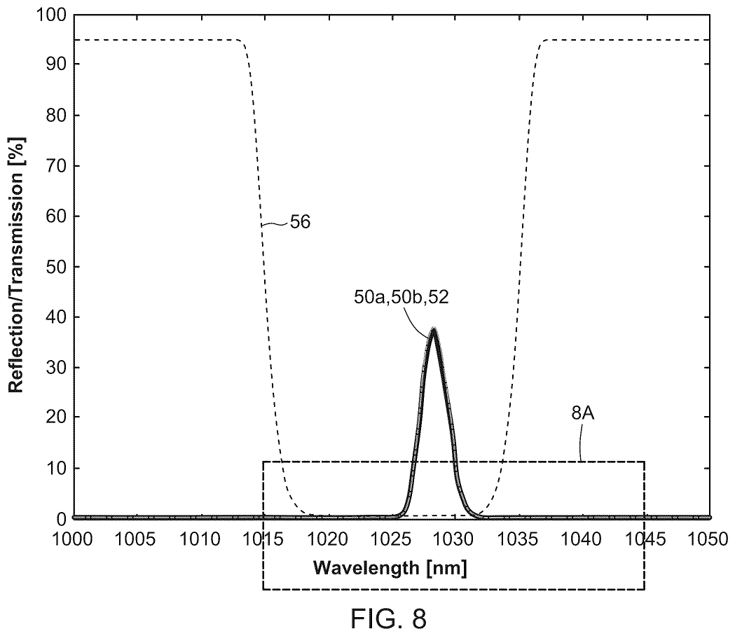

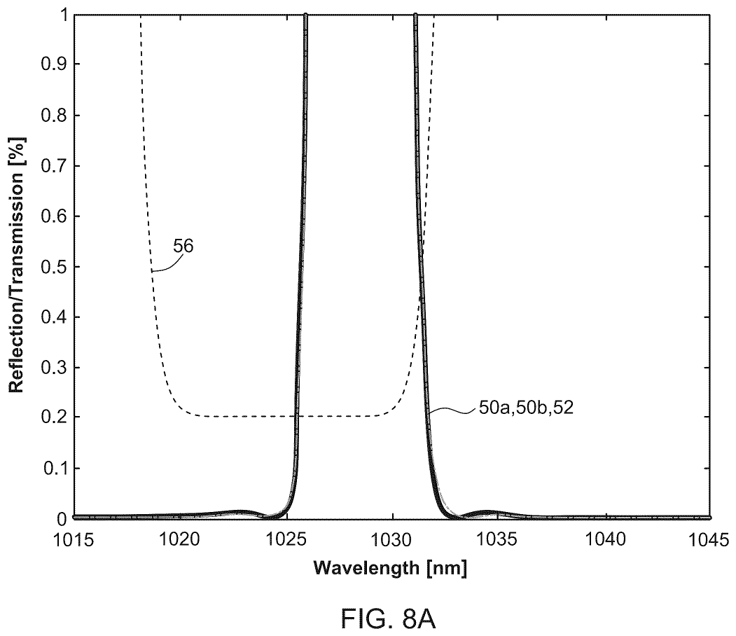

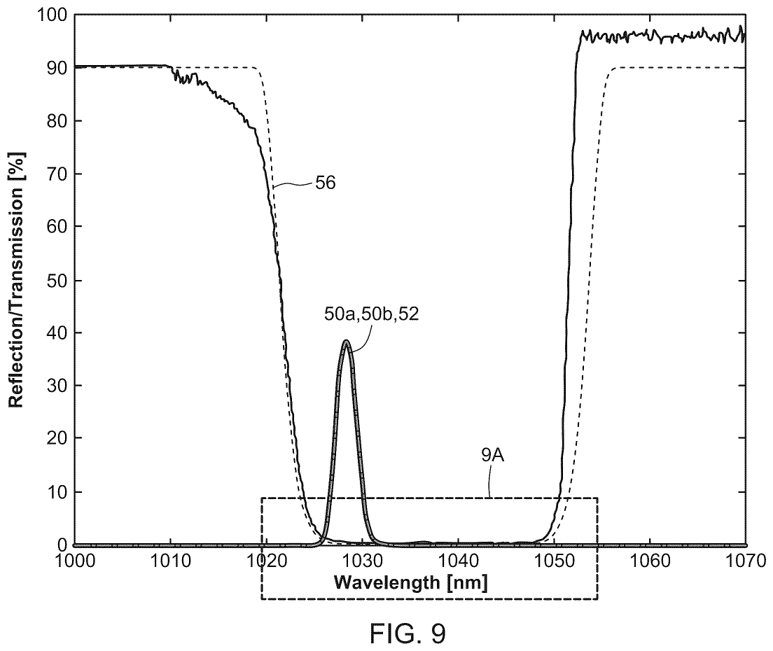

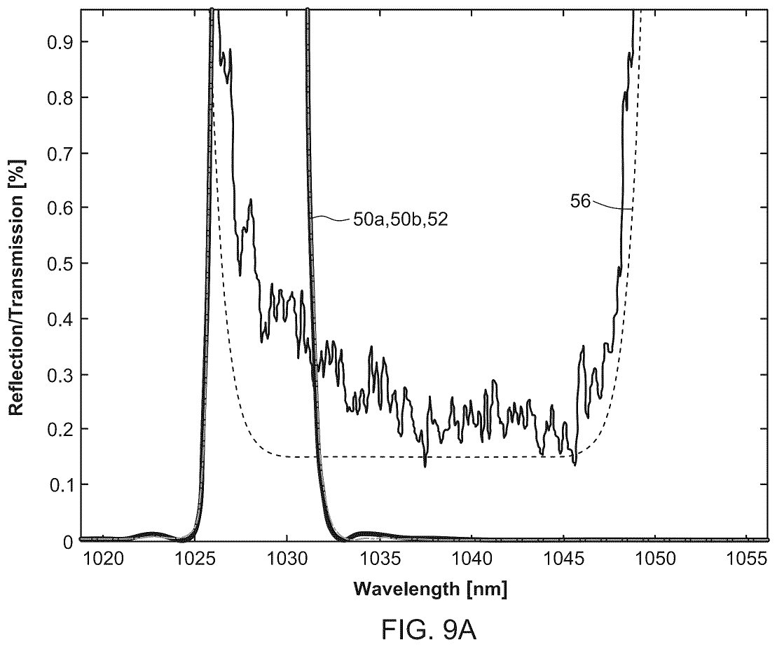

The blocking filter 26 is configured to remove light at wavelengths within a blocking spectral range from the optical path. Wavelengths within the blocking spectral range are therefore not reflected in a counterpropagating direction in the core, but instead directed outside of the core of the optical fiber 23 hosting the blocking filter 26. The blocking spectral range includes at least the overlap spectral range, as will be explained further below. In some implementations, such as for example shown in FIGS. 8 and 8A, the blocking spectral range 56 is composed of the overlap spectral range 52 of the spectrally selective filters 24a, 24b, and wavelengths immediately above the overlap spectral range 52. In other variants, such as shown in FIGS. 9 and 9A, the blocking spectral range 56 is composed of the overlap spectral range 52 of the spectrally selective filters 24a, 24b, and wavelengths immediately below the overlap spectral range 52. It will be noted that in some variants the overlap spectral range may not coincide with an end portion of the blocking spectral range and may be at another location within the blocking spectral range, inasmuch as the light pulse generator 20 is configured to provide sufficient spectral broadening of light to enable its operation as will be described further below.

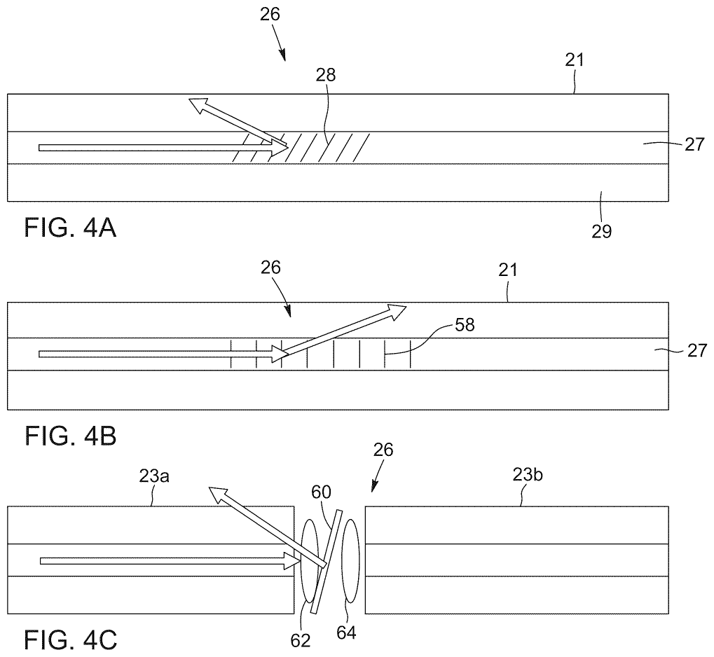

FIGS. 4A to 4C show different examples of embodiments of blocking filters 26. In some implementations, the blocking filter 26 is provided in a host optical fiber 21 having a core 27 and at least one cladding 29. Referring to FIG. 4A, in some implementations, the blocking filter 26 may be a slanted FBG provided in the core 27 of the host fiber 21. As understood by those skilled in the art, a slanted Fiber Bragg grating has grating fringes 28, defined by the refractive index modulation pattern of the grating, that are not perpendicular to the axis of the host fiber 21. Tilting the grating fringes 28 favors the coupling of light at the Bragg wavelengths from core modes to cladding modes, from which and it can be extracted from the optical path 22. Referring to FIG. 4B, in another variant, the blocking filter 26 may be embodied by a long period grating (LPG) 58 provided in the core 27 of a host optical fiber 21. Unlike an FBG, which is designed to couple light at the wavelengths of interest into counter propagating core modes, an LPG is designed to couple light into co-propagating cladding modes, from which, again, it can be extracted from the optical path 22. Referring to FIG. 4C, in yet another variant the blocking filter 26 may include a bulk or semi-bulk filter 60, such as for example a thin film spectrally selective filter or a Volume Bragg Grating (VBG). Such a variant may be combined with a fiber-based optical path 22 by extracting light from a first optical fiber segment 23a, collimating the extracted light using a first lens 62 and impinging the collimated light on the bulk filter 60, which is disposed at an angle selected to reflect wavelengths within the blocking range away from the optical path 22. The remaining wavelengths are transmitted through the bulk filter 60 and focused by a second lens 64 onto a second optical fiber segment 23b. It will be readily understood that in another variants, the blocking filter 26 may be configured such that the wavelengths within the blocking range are transmitted through the bulk filter 60 and the remaining wavelengths are reflected by the bulk filter 60 towards the second optical fiber segment.

Referring back to FIG. 1, the light pulse generator 20 further includes at least one optical gain region 30 positioned in the optical path 22 between the spectrally selective filters 24a, 24b, and at least one pump source 32 coupled to the at least one optical gain region 30.

In some implementations, the optical gain region of regions 30 may be embodied by a length of optical fiber having an active core. As well know in the art, optical amplifications can be enabled by doping the core of an optical fiber with one or more rare-earth ions such as erbium ions (Er3+), ytterbium ions (Yb3+), thulium ions (Tm3+), holmium ions (Ho3+), dysprosium ions (Dy3+), praseodymium ions (Pr3+), neodymium ions (Nd3+) or any combination thereof. In some implementations, the rare-earth ions may be embedded in a conventional silica-based matrix. Otherwise, the matrix of the optical fiber can be a low phonons energy glass such as fluoride-, chalcogenide-, chalcohalide-telluride-based glass or the like. For instance, in some embodiments, the low phonon energy glass may be a zirconium fluoride glass having a composition including ZrF such as ZBLAN (ZrF/HfF, BaF2, LaF3, NaF, and AlF3). In some other embodiments, the low phonon energy glass may be an indium fluoride glass having a composition including InF3. In alternate embodiments, the low phonon energy glass may be an aluminum fluoride glass having a composition including AlF3. In further embodiments, the low phonon energy glass may be a chalcogenide glass having a composition including As2S3, As2Se3, AsTe, AsSSe, AsSTe, GaLaS, GeAsS, GeAsSe or the like. Photonic crystal fibers, large mode area (LMA) fiber, and other type of specialty optical fiber may be used as host to the optical gain region 30 without departing from the scope of protection. It will be noted that in other variants, the optical gain region may be configured to provide gain without the need for doping with rare-earth ions. By way of example, in some variants the optical gain region 30 may provide optical gain via nonlinear effects such as stimulated Raman scattering or any other suitable nonlinear effect or combination thereof.

In the illustrated embodiment the light pulse generator 20 includes two optical gain regions 30a, 30b, positioned on either side of the blocking filter 26. A single pump source 32 is used to pump both optical gain regions 30a, 30b and is coupled to one of the extremities 25a of the optical path using a WDM coupler 34. Preferably, the pump source is configured to inject a pump beam in a core mode of the optical fiber or fibers embodying the optical path 22. In the illustrated embodiment the pump beam is adapted to pump said pair of optical gain regions along the optical fiber path.

The pump source 32 may be embodied by any light source apt to generate a pump beam which can lead to a population inversion in the associated optical gain region 30. By way of example, the pump source 32 may be embodied by a fibered laser diode optically connected to an optical fiber segment 23 of the optical path 22, for example via fusion splicing. The pump beam preferably has a spectral profile adapted to the absorption profile of the optical gain region 30. By way of example, an Ytterbium-based optical gain region may be pumped with a pump beam in the 900 nm range (typically 976 nm or 920 nm).

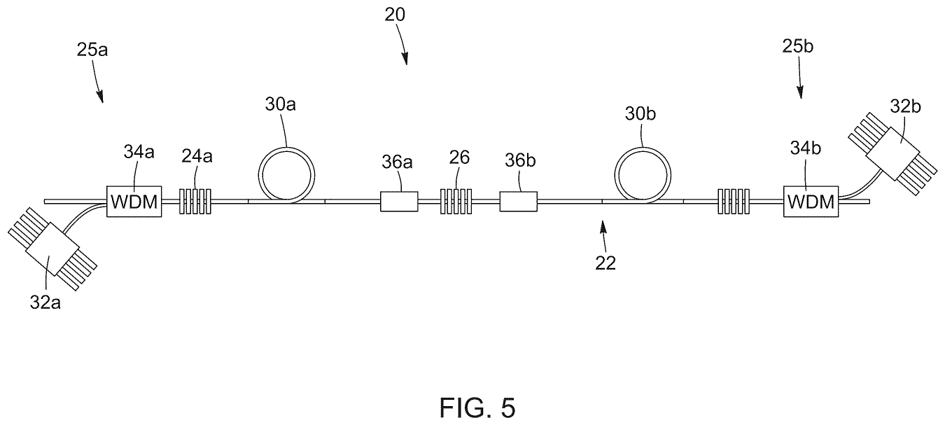

Referring to FIG. 5, there is shown an alternative configuration including a pair of optical gain regions 30a, 30b, each positioned in the optical fiber path 22 between a respective one of the FBGs 24a, 24b and the blocking filter 26, and a pair of pump sources 32a, 32b. Each pump source 32a, 32b is coupled to one of the opposite extremities 25a, 25b of the optical fiber path 22 and is configured to inject a pump beam adapted to pump the closest one of the optical gain regions 30a, 30b along the optical fiber path 22, that is, the optical gain region 30a, 30b positioned between the blocking filter 26 and the spectrally selective filter 24a, 24b at the corresponding extremity 25a, 25b. In this variant, a pair of pump strippers 36a, 36b are provided, each coupled to the optical fiber path 22 between a respective one of the optical gain region 30a, 30b and the blocking filter 26. In other variants, a single pump stripper 36 may be provided. The pump strippers 36 are configured to remove residual portions of the pump beam unabsorbed by the optical gain regions 30a, 30b.

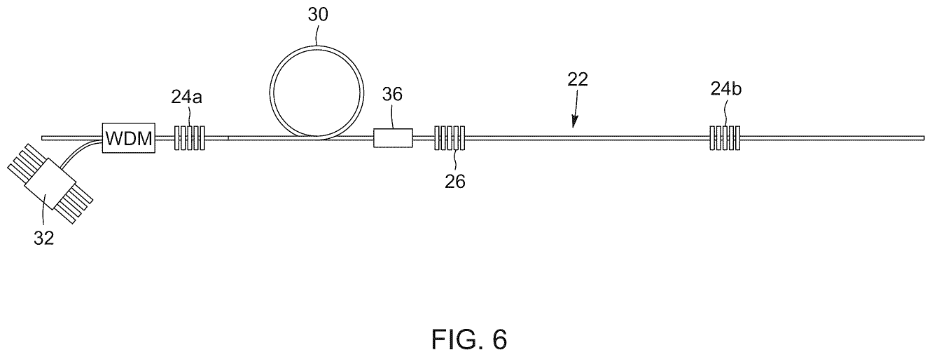

Referring to FIG. 6, there is shown an alternative configuration including single optical gain region 30, positioned in the optical fiber path 22 between one of the FBGs 24a and the blocking filter 26. A single pump source 32 is provided and coupled to one of the opposite extremities 25a of the optical fiber path 22, preferably the extremity closest to the optical gain region 30. The pump source 32 is configured to inject a pump beam adapted to pump the optical gain region 30. In some implementations, a pump stripper 36 may be provided and coupled to the optical fiber path 22 between the optical gain region 30 and the blocking filter 26. Preferably, the pump stripper 36 is configured and position to remove residual pump light from the optical fiber path 22 if the presence of such residual pump light at the output of the light pulse generator is undesired. In other variants, one or more pump strippers may be provided at other locations along the optical path. In yet another variant, the residual pump light may be conserved along the optical fiber path and used for another purpose, such as pumping an additional optical gain region inside or outside of the light pulse generator.

### Generation of Ultrashort Light Pulses

Referring to FIGS. 8 and 8A, reflectivity profiles (calculated and measured) of the spectrally selective filters 24a, 24b and blocking filter 26 for this example are illustrated. In this example, both spectrally selective filters 24a, 24b have reflectivity bands 50a, 50b which can be seen as completely overlapped on the scale of the graph. Therefore, the reflectivity band 50a, 50b of both spectrally selective filters 24a, 24b as well as their overlap spectral range 52 can be observed to span the range between about 1025 nm and about 1032.5 nm. The blocking spectral range 54 of blocking filter 26 has a flat top shape spanning the wavelength range between about 1020 nm and 1055 nm. As will be noted, the blocking spectral range 54 includes the overlap spectral range and beyond.

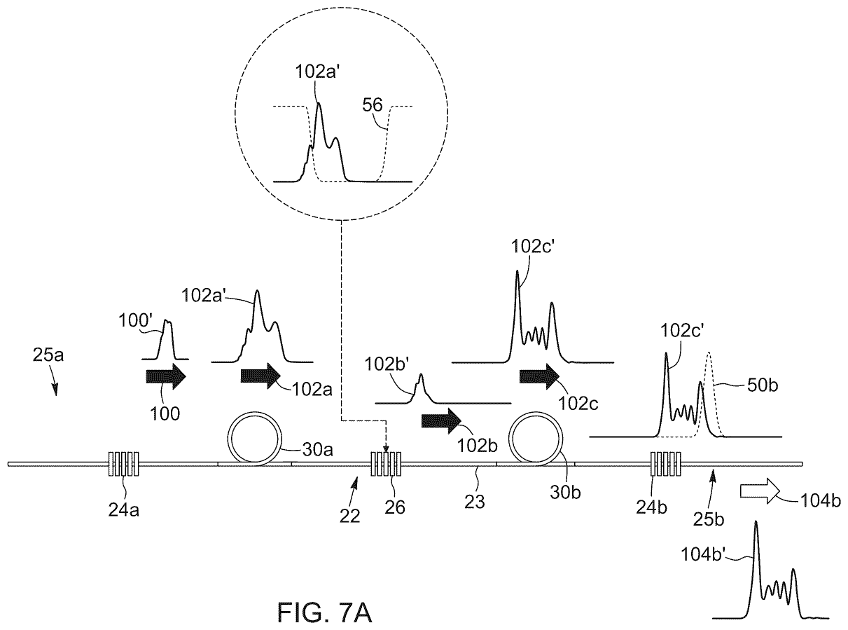

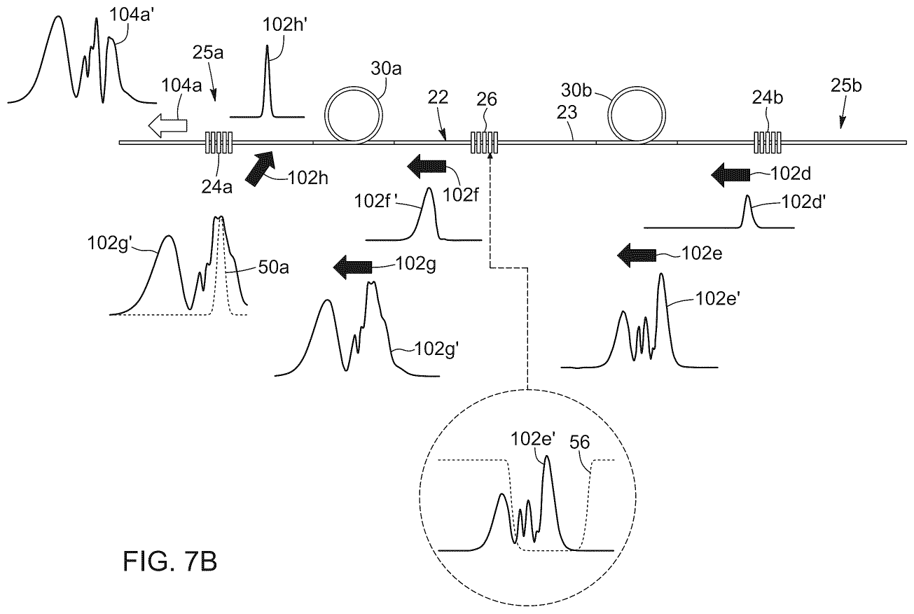

Referring to FIGS. 7A and 7B, the process of generating ultrashort light pulses using the light pulse generator according to the embodiment of FIG. 1 is explained.

The process begins with the circulation of a seed laser pulse 100 along the optical path 22. Preferably, the light pulse generator includes a starting mechanism apt to launch the seed light pulse 100 along a core mode of the optical fiber 23 embodying the optical path. In some embodiments, a temporarily change in the strain of the optical fiber segment 23 hosting one of the filters 24a, 24b or 26 may be used to ease the starting of the laser. A change in tension may for example be achieved by mechanically stretching the optical fiber segment 23 or compressing the segment, that is reducing the pre-existing strain in the fiber segment. In other variants, heating or cooling of the blocking filter 26 and/or of the first and/or of the second spectrally selective filters 24a, 24b may be used. In doing so, a small spectral band can oscillate between both filters 24a and 24b without being blocked by the blocking filter 26, thus generating an initial lasing to start the pulsing action once the filters are returned to their original states where the overlap spectral range of filters 24a-b is blocked by the blocking filter 26. In other variants, to facilitate the starting, pump modulation may alternatively be used to generate Q-switching within the cavity, along with the spectral shifting just described. In yet another variant the starting mechanism may include a starting arm generating the seed light pulse using an external ultrafast laser temporarily connected to one of the extremities of the optical path

In the illustrated example of FIG. 7A, the seed light pulse 100 is shown as injected at the left-hand extremity 25a of the optical path 22, for ease of reference. The seed laser pulse 100 has an initial spectral profile 100′ which depends on the nature and operation of the starting mechanism. The initial spectral profile 100′ preferably includes wavelengths within the blocking spectral range 56.

As the seed light pulse 100 propagates along the optical path 22, it is reflected back and forth between the first and second spectrally selective filters 24a, 24b, the optical path 22 thereby defining a cavity between these two filters 24a, 24b, and the travelling light pulse defining a cavity pulse of growing intensity and varying spectral contents, as explained below.

Initially, the cavity pulse 102a propagates in a first direction, which is towards the right in the illustrated embodiment, along the optical path 22 on the left side of the cavity and through the first optical gain region 30a, gaining intensity from the optical gain region. As this propagation occurs, the spectrum of the cavity pulse 102a is broadened, resulting in a spectral profile 102a′. Both the amplification of the cavity pulse 102a and its spectral broadening can be observed from a comparison of its spectral profile 102a′ with the initial spectral profile 100′ of the seed pulse 100. It will be noted that in this example, the broadened spectral profile 102a′ of the cavity pulse 102a include wavelengths shorter and longer than the wavelengths of the initial spectral profile 100′, some of which extending beyond the blocking spectral range 56. Upon reaching the blocking filter 26, the spectral components of the cavity pulse 102a within the blocking spectral range 56 are extracted from the optical path 22, the resulting cavity pulse 102b retaining only the wavelengths outside of the blocking range 56, as shown in the spectral profile 102b′. As the cavity pulse 102c continue propagating towards the right along the optical path 22 in the right side of the cavity, it is amplified by the second optical gain region 30b, and spectrally broadened to again extend to shorter and higher wavelengths (spectrum 102c′) than those allowed through by the blocking filter 26, and now includes wavelengths extending within the blocking spectral range 56 and the overlap spectral band 52. Upon reaching the second spectrally selective filter 24b, only the wavelengths within the corresponding reflective spectral band 50b are reflected, transmitting all other wavelengths through to the second output. In some implementations, light at the transmitted wavelengths may define an output pulse 104b having an output spectral profile 104b′ having output wavelengths. In the illustrated example, the output wavelengths mainly include wavelengths immediately adjacent the reflective spectral band 50b of the second spectrally selective filter 24b on the blue (shorter) side, as well as lower intensity light peaks at wavelengths on the red (longer) side.

Referring now to FIG. 7B, the reflected cavity pulse 102d, now having a spectral profile 102d′ corresponding to the reflectivity band 50b of the second spectrally selective filter 24b, then makes another pass along the optical path 22, this time travelling in a second direction opposite the first direction, towards the left in the illustrated embodiment. As it propagates along the right side of the cavity and through the second optical gain region 30b, the cavity pulse 102e is again amplified and spectrally broadened according to spectrum 102e′. Upon reaching the blocking filter 26, all wavelengths within the blocking spectral range 56 are extracted from the optical path 22, again leaving only the wavelengths outside of the blocking range as the cavity pulse 102f of spectrum 102f′. The cavity pulse 102f then propagates along the left side of the optical path 22, towards the left, and is spectrally broadened and amplified by the first optical gain region 30a, becoming cavity pulse 102g of spectrum 102g′. Upon reaching the first spectrally selective filter 24a, the spectral portion of the cavity pulse 102g outside of the reflective spectral band 50a of the first spectrally selective filter 24a, are transmitted though, and optionally define output pulses 104a at output wavelengths 104a′. In the illustrated embodiment the output pulse 104a includes wavelength immediately adjacent the reflective spectral band 50a of the first spectrally selective filter 24a on the blue (shorter) and red (longer) side. The spectral portion′ of the cavity pulse 102g within the reflective spectral band 50a of the first spectrally selective filter 24a is reflected back along the cavity, generating cavity pulse 102h with spectrum 102h′ and the cycle begins again.

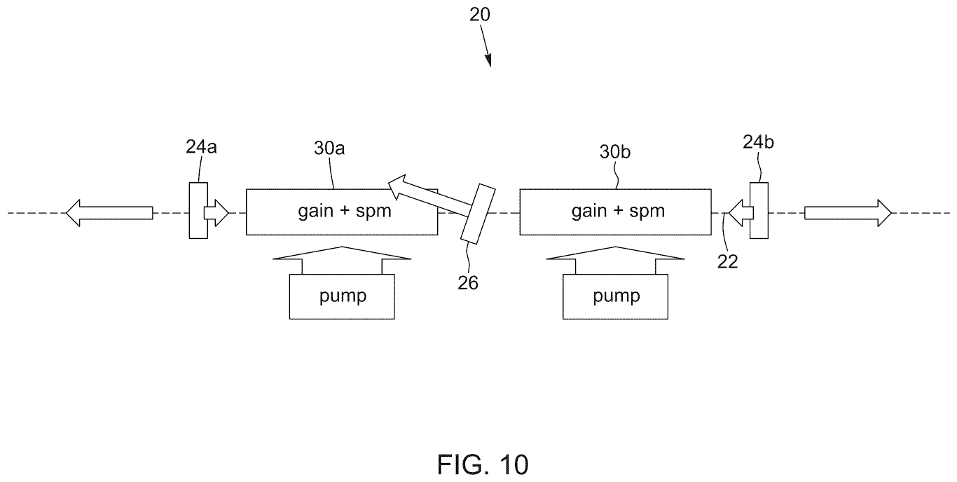

As will be readily understood by one skilled in the art, in some embodiments the light pulse generator need not be implemented in an all-fiber configuration. Referring to FIG. 10, one example of a free-space configuration embodying the present light pulse generator 20 is shown. In this example, the optical gain region or regions may be embodied by doped glass, for example Nd: YAG, or other doped crystals. The spectrally selective filters 24a, 24b and the blocking filter 26 may for example be Volume Bragg gratings (VBGs) or thin film filters having the desired reflectivity profiles. The blocking filter may be positioned at an orientation with respect to incoming light which deflects light within the blocking spectral range out of the optical path 22 and propagates light at other wavelengths along the optical path.

### Optical Systems

In accordance with one aspect, there is provided an optical system including a light pulse generator according to an embodiment of the present description.

In some embodiments, the optical system may include the light pulse generator combined with a pulse compressor to further compress the output light pulses. The Pulse compressor may be a bulk compressor or a fiber-based compressor. In another variant, the optical system may further include a pulse stretcher disposed between the light pulse generator and the pulse compressor.

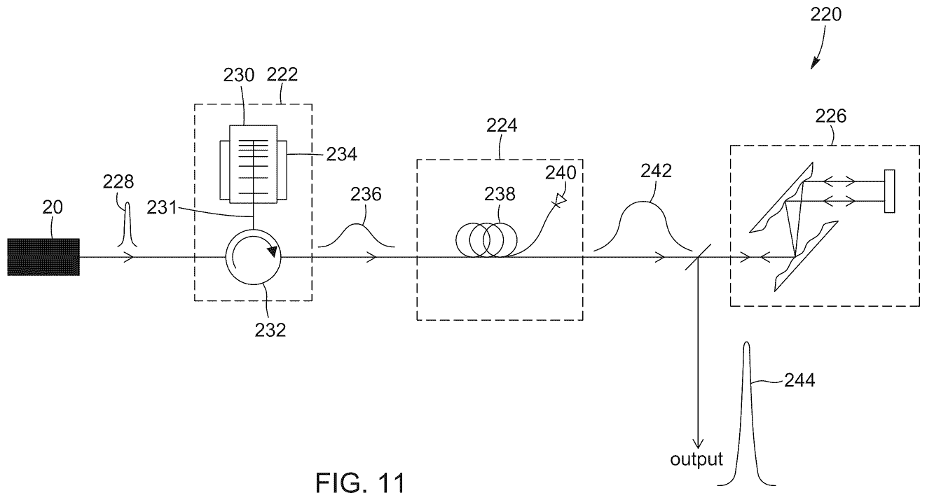

In some implementations, the optical system may be a Chirped Pulse Amplification (CPA) system. Chirped pulse amplification (CPA) is a widely used technique to amplify light pulses to high energies, while mitigating the deleterious effects of nonlinearities. This is achieved by temporally spreading the pulse before amplification to reduce peak power, followed by post-amplification compression, resulting in a short, high energy pulse train. Referring to FIG. 11, an example of a CPA system 220 is illustrated. The illustrated CPA system 220 includes a light pulse generator 20 according to any embodiment of the present description, a fiber pulse stretcher 222, an amplifier 224 and a compressor 226. The ultrashort light pulses generated by the light pulse generator 20 serve as input optical pulses 228 to the CPA system 220.

In some implementations, the pulse stretcher 222 includes a fiber Bragg grating (FBG) 230. The FBG 230 has a dispersion profile designed to stretch each of the optical pulses 228 into time-spread spectral components, such that each input optical pulse 228 is spread into a longer pulse of similar energy, defining a stretched optical pulse 236. The pulse stretcher 222 may include a circulator 232 directing the input optical pulses 228 towards the FBG 230, and then receiving and directing the reflected stretched optical pulses 236 from the FBG 230 towards the amplifier 224. The pulse stretcher 22 may further include a tuning mechanism 234 coupled to the FBG 30 for tuning its dispersion profile. It will be readily understood by one skilled in the art that other configurations may be envisioned. Preferably, the pulse stretcher 222 is entirely fiber-based.

The CPA system 220 next includes an amplifier 224. The amplifier 224 may be embodied by any light amplification device suitable to increase the intensity of the stretched optical pulses 236. In the illustrated embodiment, the amplifier 224 is a fiber amplifier. The expression “fiber amplifier” is understood to refer to any device wherein an optical fiber is used as a gain medium to amplify light. Typically, the fiber amplifier includes a length of doped optical fiber 238 provided with rare-earth dopants such as erbium, ytterbium or the like. The doped optical fiber 238 is pumped using a pump source 240. The pump light from the pump source 240 may be injected into the doped optical fiber 238 in a copropagating or counter propagating direction with respect to the propagation of the stretched optical pulses 236 being amplified. It will be readily understood that the fiber amplifier 224 may be configured in a variety of manners and may include specialty fibers or components, multiple amplification stages, etc. In other variants, the amplifier 224 may be a non-fiber device and may for example be implemented in various materials and geometries such as a rod, slab, disk, etc.

The fiber amplifier 224 receives and amplifies the stretched optical pulses 236 into amplified stretched optical pulses 242. As the energy of each input optical pulse 28 is spread over the longer stretched optical pulse 236, the instantaneous peak power along the pulse is reduced, allowing its amplification while avoiding or mitigating non-linear effects known to affect pulses having high peak power.

It will be readily understood that the pulse stretcher 222 and fiber amplifier 224 need not be immediately consecutive and that the CPA system 220 may include additional components or devices in-between such as couplers, pre-amplification stages, etc.

The compressor 226 is provided downstream the fiber amplifier 224 and is for compressing the amplified stretched optical pulses 242 into amplified compressed optical pulses 244. In some implementations, the compressor 226 is a bulk compressor, such as for example in the form of a Treacy grating pair. In one example, the bulk compressor may be according to an embodiment described in U.S. Pat. No. 11,349,271 (FIXED BULK COMPRESSOR FOR USE IN A CHIRPED PULSE AMPLIFICATION SYSTEM), the entire contents of which is incorporated herein by reference. In another example, the compressor may be based on a Volume Bragg Grating (VBG). In yet another example, the compressor 226 may be fiber-based.

Numerous modifications could be made to the embodiments above without departing from the scope of protection.

1. A light pulse generator for generating ultrashort light pulses, comprising:
an optical path apt to induce a spectral broadening of light propagating therealong;
a pair of spectrally selective filters disposed at opposite extremities of the optical path and each having a corresponding reflective spectral band, the reflective spectral bands of the spectrally selective filters substantially overlapping, thereby defining an overlap spectral range;
at least one optical gain region positioned in the optical path between the spectrally selective filters;
at least one pump source coupled to the at least one optical gain region; and
a blocking filter positioned between the spectrally selective filters and configured to remove light at wavelengths within a blocking spectral range from the optical path, the blocking spectral range including at least the overlap spectral range.

2. The light pulse generator according to claim 1, wherein the optical path is composed of at least one segment of optical fiber and the spectrally selective optical filters are Fiber Bragg Gratings (FBGs).

3. (canceled)

4. The light pulse generator according to claim 1, wherein the overlap spectral range is at least about 10% of the reflective spectral band of each spectrally selective filters.

5. The light pulse generator according to claim 1, wherein the overlap spectral range is at least about 30% of the reflective spectral band of each spectrally selective filters.

6. The light pulse generator according to claim 1, wherein the overlap spectral range is at least about 80% of the reflective spectral band of each spectrally selective filters.

7. The light pulse generator according to claim 1, wherein the overlap spectral range is at least about 90% of the reflective spectral band of each spectrally selective filters.

8. The light pulse generator according to claim 1, wherein the overlap spectral range substantially corresponds to the entire reflective spectral bands of at least one the spectrally selective filters.

9. The light pulse generator according to claim 1, wherein the reflective spectral bands of the spectrally selective filters have a Gaussian-like spectral profile.

10. The light pulse generator according to claim 1, wherein the blocking filter is a slanted Fiber Bragg Grating, a Long Period Grating or a bulk filter.

11. (canceled)

12. (canceled)

13. The light pulse generator according to claim 1, wherein the blocking range of the blocking filter is composed of the overlap spectral range and wavelengths below and/or above said overlap spectral range.

14. (canceled)

15. (canceled)

16. The light pulse generator according to claim 1, comprising a light output coupled to one of the opposite extremities of the optical path and configured to output light transmitted through the corresponding spectrally selective filter.

17. The light pulse generator according to claim 1, comprising:
a pair of light outputs, each of said light outputs coupled to a corresponding one of the opposite extremities of the optical path and configured to output light transmitted through the corresponding spectrally selective filter; and
a combiner configured to combine the light outputted by the pair of light outputs into a combined output beam.

18. (canceled)

19. (canceled)

20. The light pulse generator according to claim 1, wherein the at least one optical gain region comprises two optical gain regions positioned on either side of the blocking filter.

21. (canceled)

22. (canceled)

23. (canceled)

24. The light pulse generator according to claim 1, wherein:
the optical path is a free-space path; and
each of the spectrally selective filters and the blocking filters are Volume Bragg Gratings or thin film filters, and the blocking filter is positioned at an orientation with respect to incoming light which deflects light within the blocking spectral range out of the optical path and propagates light at other wavelengths along the optical path.

25. (canceled)

26. A Chirped Pulse Amplification (CPA) system, comprising, successively:
a light pulse generator according to claim 1;
a pulse stretcher configured to stretch each the ultrashort light pulses from the light pulse generator into time-spread spectral components, thereby defining a stretched optical pulse;
an amplifier configured to increase a light intensity of the stretched optical pulses; and
a pulse compressor for compressing the amplified stretched optical pulses into amplified compressed optical pulses.

27. A method for generating ultrashort light pulses, comprising:
circulating a cavity pulse in a cavity defined by an optical path apt to induce a spectral broadening of light propagating therealong and a pair of spectrally selective filters disposed at opposite extremities of the optical path, each spectrally selective filter having a corresponding reflective spectral band, the reflective spectral bands of the spectrally selective filters substantially overlapping, thereby defining an overlap spectral range;
amplifying and spectrally broadening the cavity pulse as it propagates within said cavity;
filtering the cavity pulse using a blocking filter positioned between the spectrally selective filters and configured to remove light at wavelengths within a blocking spectral range from the optical path, the blocking spectral range including at least the overlap spectral range;
at each spectrally selective filter, reflecting a portion of the cavity pulse matching said overlap spectral range for another pass within said cavity; and
at one or both of said spectrally selective filters, outputting light transmitted through said spectrally selective filter as said ultrashort light pulses.

28. (canceled)

29. (canceled)

30. (canceled)

31. (canceled)

32. (canceled)

33. (canceled)

34. (canceled)

35. The method according to claim 27, wherein the blocking filter is a slanted fiber Bragg Grating, a Long Period Grating or a bulk filter.

36. (canceled)

37. (canceled)

38. The method according to claim 27, wherein the blocking range of the blocking filter is composed of the overlap spectral range and wavelengths above said overlap spectral range.

39. The method according to claim 27, wherein the blocking range of the blocking filter is composed of the overlap spectral range and wavelengths below said overlap spectral range.

40. The method according to claim 27, wherein the blocking range of the blocking filter is composed of the overlap spectral range and wavelengths both below and above said overlap spectral range.
